(19) United States
(12) Patent Application Publication
(10) Pub. No.: US 2025/0067162 A1
(43) Pub. Date: Feb. 27, 2025

(54) METHODS AND SYSTEMS FOR DETERMINING WELL CONTROL TECHNIQUE

(71) Applicant: SAUDI ARABIAN OIL COMPANY, Dhahran (SA)

(72) Inventor: Haytham Mohamed Atta ELKAMASH, Dhahran (SA)

(73) Assignee: SAUDI ARABIAN OIL COMPANY, Dhahran (SA)

(21) Appl. No.: 18/455,104

(22) Filed: Aug. 24, 2023

(51) Int. Cl. E21B 44/00; G05B 13/02

(52) U.S. Cl. CPC E21B 44/00; G05B 13/028

(57) ABSTRACT

A method of recommending a well control method includes receiving well control input parameters including oil and gas well data, oil and gas equipment data, formation data, and candidate well control methods, selecting one or more candidate well control methods from the well control input parameters, assigning a variable weight to each candidate well control method for each of one or more tested variables of the well control input parameters, calculating a total weight for each candidate well control method from the variable weights for each of the one or more tested variables, and determining a recommended well control method based upon the total weight for each candidate well control method.

### FIELD OF THE DISCLOSURE

The present disclosure relates generally to well control techniques and, more particularly, to methods and systems for determination of well control techniques and generation of corresponding well killing parameters.

### BACKGROUND OF THE DISCLOSURE

During oil and gas extraction processes, particularly while drilling wellbores, the unexpected release of formation fluids can create dangerous conditions and can require rapid correction. Well control operations are performed in these situations, such that the unexpected release of formation fluids, or “kick” can be controlled and dangers to personnel and equipment can be limited. Many conventional and non-conventional processes can be utilized in well control operations, and can be used to limit blowouts, control internal pressures, and kill producing wells before catastrophic failure. To this end, an operator can utilize an existing kick, introduce kill mud, cycle pressures through the wellbore, and perform many other operations in an attempt to control or kill a producing well.

The proper well control operation can vary for each well based upon a plurality of variables regarding the well construction, profile, kick composition and volume, as well as time-varying parameters such as current drill string location. Accordingly, the success of a well control operation can depend upon expertise of an operator to identify pertinent characteristics, quickly assess the available options, and perform the correct calculations for controlling the well. If an operator is inexperienced, misses an important characteristic, or fails to make a timely determination, the kick can lead to a blowout or other catastrophe that can endanger personnel and property. Further, even if a viable well control operation is chosen by an operator, a more ideal or cost-friendly operation can be overlooked in the execution of the well control process.

Accordingly, a system and method for automatically recommending an optimal kill method and generating a corresponding kill sheet is desirable.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a system for recommending a well control method includes a well control evaluator for receiving a plurality of input parameters relating to an oil and gas well and equipment. The well control evaluator includes a well volume calculator operable to determine volume parameters for the oil and gas well and a drill string of the oil and gas equipment, a kick tolerance calculator operable to determine a maximum kick tolerance acceptable within the oil and gas well, and a kill method determination tool for determining a recommended well control method via an engine using the volume parameters, maximum kick tolerance, and input parameters, and generating a kill sheet for the recommended well control method via a kill sheet generator, wherein the kill sheet includes parameters and steps for performance of the recommended well control method.

In another embodiment, a method of recommending a well control method includes receiving well control input parameters including oil and gas well data, oil and gas equipment data, formation data, and candidate well control methods, selecting one or more candidate well control methods from the well control input parameters, assigning a variable weight to each candidate well control method for each of one or more tested variables of the well control input parameters, calculating a total weight for each candidate well control method from the variable weights for each of the one or more tested variables, and determining a recommended well control method based upon the total weight for each candidate well control method.

In a further embodiment, a machine-readable storage medium stores thereon a computer program for recommending a well control method of an oil and gas well using one or more well control input parameters. The computer program includes a routine of set instructions for causing the machine to perform the steps of selecting one or more candidate well control methods for assessment, assigning a variable weight to each candidate well control method for each of one or more tested variables of the well control input parameters, calculating a total weight for each candidate well control method from the variable weights for each of the one or more tested variables, and determining a recommended well control method based upon the total weight for each candidate well control method.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a block diagram of a system for recommending an optimal kill method based upon well parameters, in accordance with certain embodiments

FIG. 2 is an example of a method for recommending a kill operation utilizing a decision tree when a drill bit is not on a bottom of the well.

FIG. 3 is an example of a method for recommending a kill operation utilizing a decision tree when a drill bit is present on a bottom of the well.

FIG. 4 is an example of a method for recommending a kill operation utilizing a weighting method.

FIG. 5 is an example user interface for selection of a kill method by an operator, according to an embodiment of the present disclosure.

FIG. 6 is an example kill sheet for performance of a selected or recommended kill method, according to an embodiment of the present disclosure.

FIG. 7 is a block diagram of a computer system that can be used to implement one or more of the systems or methods described herein in accordance with certain embodiments.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to well control techniques and, more particularly, to methods and systems for determination of well control techniques and generation of corresponding well killing parameters. In accordance with certain embodiments, one or more methods can be utilized to determine a recommended well control operation based upon the unique fact patterns of the well of interest. The fact patterns can include a plurality of parameters, such as well and equipment dimensions, well profiles, kick type and volume, and several other situational variables. The system and methods can be utilized to rapidly and automatically recommend a well control operation using these fact patterns. Further, the systems and methods can enable rapid performance of the well control operation through generation of a kill sheet that includes all calculations, parameters, and timing associated with performance of the well control operation. The automatic recommendation and calculation of the required well control information can enable rapid response to kicks and other well control issues, such that damages to equipment and dangers to personnel can be limited. Further, the possibility of human error and the reliance on experience for determination of an optimal well control operation can be removed from the well control process.

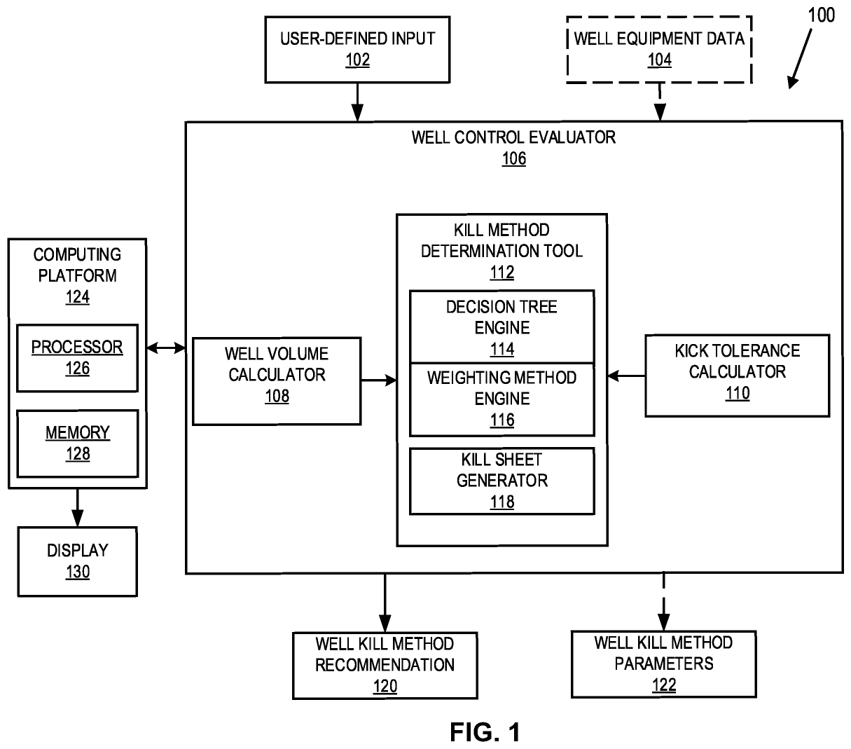

FIG. 1 is a block diagram of a system 100 for recommending an optimal kill method based upon well parameters, in accordance with certain embodiments. The system 100 can receive input data in the form of a user-defined input 102 for determination of an optimal kill method. The input data included in the user-defined input 102 can include, but is not limited to, formation strength data, drill string dimension, hole and casing sizes, setting depths, well total depths, well profile data, kick data, hydrogen sulfide presence probability, mud data, pump output, slow circulation rate pressure, kick size, shut-in pressures, and formation injectivity data. In alternate embodiments, the system 100 can receive input data directly as well equipment data 104 that can be transmitted directly from sensors and operational well equipment. In further embodiments, the system 100 can receive input data in both the form of a user-defined input 102 and as well equipment data 104. In this way, some input data can be manually entered while further data is directly sourced from operational equipment.

The user-defined input data 102 and/or the well equipment data 104 can be received by a well control evaluator 106 for assessing an optimal well kill method recommendation based upon the received parameters. The well control evaluator 106 can include a well volume calculator 108 therein, such that further initial calculations can be performed on the input data. The well volume calculator 108 can receive one or more parameters of the input data, such as dimensional and depth information, and can calculate both the projected volume of a drill string and the projected volume of an annulus in terms of barrels, gallons, or strokes. The well volume calculator 108 can use these calculations independently, or can use the total well volume in further assessment of the well through summation of the drill string and annulus projected volumes.

Similarly, the well control evaluator 106 can further include a kick tolerance calculator 110. The kick tolerance calculator 110 can further receive parameters of the input data such as the expected influx gradient and volume of influx data, for calculations utilized in kicks within the well to be controlled. The kick tolerance calculator 110 can determine both the tolerance volume of a kick based upon the maximum volume of influx and the intensity of the kick. The kick tolerance calculator 110 can output a number of barrels or gallons tolerated in a kick as well as measurement in pounds-per-gallon for the kick intensity that can be utilized in the well.

Both the well volume calculations from the well volume calculator 108 and the kick parameters from the kick tolerance calculator 110 can be provided to the kill method determination tool 112 of the well control evaluator 106. Additionally, the kill method determination tool 112 can receive some or all of the input data received as user-defined input data 102 and/or the well equipment data 104 to perform further calculations and determinations. The kill method determination tool 112 can utilize the available information to recommend an optimal well kill method for the well defined by the input data.

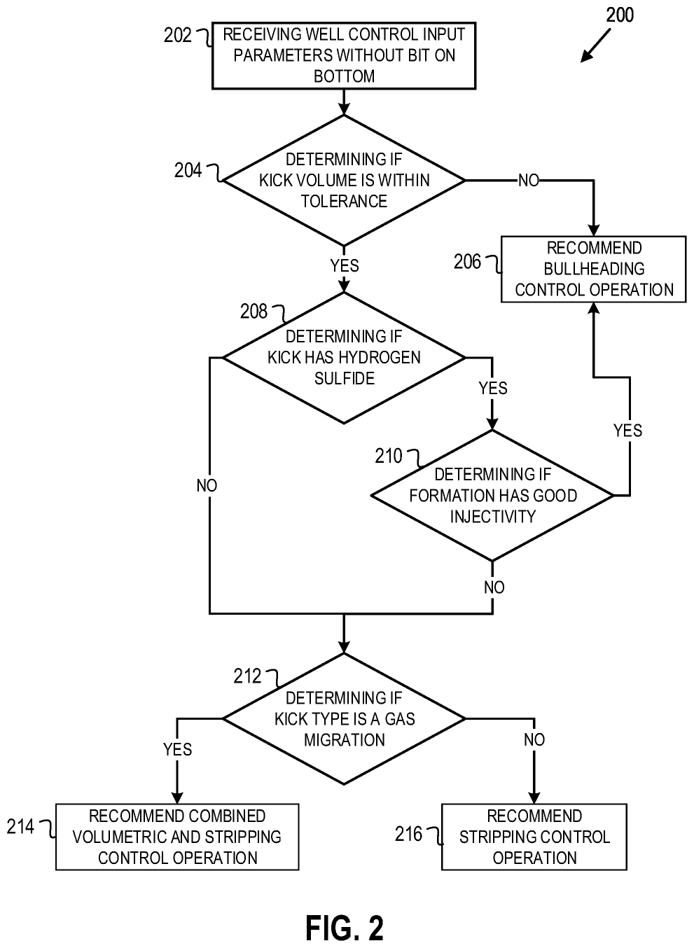

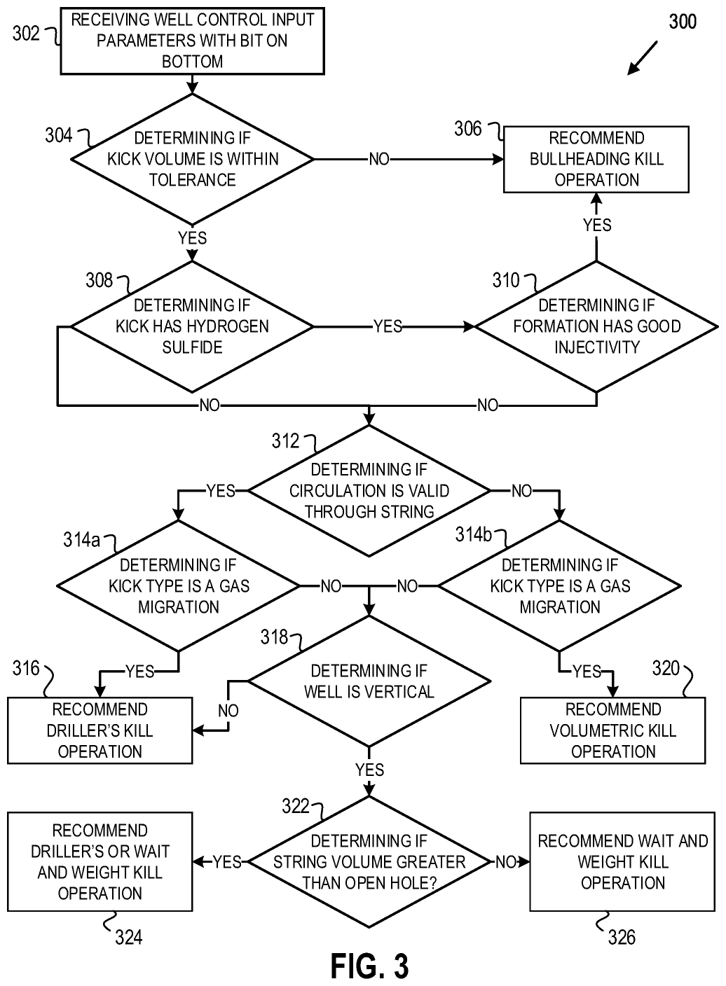

In some embodiments, the kill method determination tool 112 can include a decision tree engine 114. The decision tree engine 114 can utilize fact patterns of the well to advance through a decision tree to recommend an optimal well kill method following a plurality of binary decisions. For example, if a drill bit is on the bottom of a well and the kick volume is determined to not be within tolerance, the decision tree engine 114 can recommend a bullheading operation. Further decision tree examples are discussed below in FIGS. 2 and 3.

In further embodiments, the kill method determination tool 112 can include a weighting method engine 116. The weighting method engine 116 can utilize fact patterns of the well to answer a plurality of questions regarding the well at issue. For example, the weighting method engine 116 can determine if a kick is oil, gas, or water, or can determine a comparison between the drill string volume and open-hole volume of the well. Based upon the answers to the weighting questions, the weighting method engine 116 can assign a varying weight to each proposed well kill method. The well kill methods can include, but are not limited to, driller's, wait and weight, volumetric, stripping operation, lubricate and bleed, bullheading, combined volumetric and stripping operation, and a combination thereof. In an example, the possibility of hydrogen sulfide in the kick can introduce a negative weighting value to all aforementioned methods except for a positive weighting value assigned to bullheading. After a weight has been assigned to each method for each question, the weighting method engine 116 can determine a summation of the weights for each method. The weighting method engine 116 can then output a comparison between methods based upon the weighted sums, or the “selection index”, for direct comparison of favorable conditions for each kill method.

Following determination of an optimal kill method in the decision tree engine 114 or the weighting method engine 116, the kill method determination tool 112 can further include a kill sheet generator 118. The kill sheet generator 118 can utilize the input data as well as the recommended kill method in order to generate a kill sheet which provides a detailed report of the kill method operation and notable calculations or pertinent data. The kill sheet generator 118 can generate a unique kill sheet for each aforementioned kill method, such that a bullheading operation can include a casing pressure schedule plot while a volumetric operation can include a plot denoting a volume to bleed per step and a shut-in case pressure at each step.

The well control evaluator 106 can output both a well kill method recommendation 120 as a recommendation or comparison of available methods, as well as the well kill method parameters 122 in the form of a kill sheet. The well kill method recommendation 120 and well kill method parameters 122 can be output to an operator for review of options and detailed instructions for performing a well kill operation. Alternatively, the well kill method recommendation 120 and well kill method parameters 122 can be directly transmitted to automated well equipment for performance of a well kill operation.

It will be appreciated that one or more of the well control evaluator 106 components, such as the well volume calculator 108, the kick tolerance calculator 110, and the kill method determination tool 112, can be implemented (e.g., as machine readable instructions) on a computing platform 124. The computing platform 124 can include one or more computing devices selected from, for example, a desktop computer, a server, a controller, a blade, a mobile phone, a tablet, a laptop, a personal digital assistant (PDA), and the like. The computing platform 124 can include a processor 126 and a memory 128. By way of example, the memory 128 can be implemented, for example, as a non-transitory computer storage medium, such as volatile memory (e.g., random access memory), non-volatile memory (e.g., a hard disk drive, a solid-state drive, a flash memory, or the like), or a combination thereof. The processor 126 can be implemented, for example, as one or more processor cores.

The memory 128 can store machine-readable instructions that can be retrieved and executed by the processor 126. Each of the processor 126 and the memory 128 can be implemented on a similar or a different computing platform. The computing platform 124 can be implemented in a cloud computing environment (for example, as disclosed herein) and thus on a cloud infrastructure. In such a situation, features of the computing platform 124 can be representative of a single instance of hardware or multiple instances of hardware executing across the multiple of instances (e.g., distributed) of hardware (e.g., computers, routers, memory, processors, or a combination thereof). Alternatively, the computing platform 124 can be implemented on a single dedicated server or workstation. Further, the computing platform 124 can provide information and graphical representations to a display 130 for view by a user or operator.

In view of the structural and functional features described above, example methods will be better appreciated with reference to FIGS. 2-4. While, for purposes of simplicity of explanation, the example methods of FIGS. 2-4 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the methods, and conversely, some actions can be performed that are omitted from the description.

FIG. 2 is an example of a method 200 for recommending a kill operation utilizing a decision tree when a drill bit is not on a bottom of the well. The method 200 can be implemented by the decision tree engine 114 of the kill method determination tool 112, as shown in FIG. 1. Thus, reference can be made to the example of FIG. 1 in the example of FIG. 2. The method 200 can begin at 202 with receiving well control input parameters in which the drill bit is not on the bottom of the well. The well control input parameters received at 202 can be the user-defined input 102 and/or well equipment data 104 input to the well control evaluator 106 of FIG. 1. In some embodiments, at 202 the well control input parameters can be pre-processed, as by the well volume calculator 108 and the kick tolerance calculator 110 of FIG. 1.

The method 200 can continue at 204 with determining if the kick volume is within the well's tolerance for a kick. At 204, the influx volume of the kick can be compared to the calculated kick tolerance to determine how the kick would affect the present well. If the influx volume exceeds the well's kick tolerance, the kick can be forced back downhole into a formation within the well and the method 200 can continue at 206. At 206, the system can recommend the utilization of a bullheading kill operation as the well control method. As stated above, the influx volume of the kick would exceed the kick tolerance of the formation in the well, and utilizing a bullheading operation to force the kick back into the formation can result in a controlled well.

If the kick volume is within the kick tolerance of the formation in the well at 204, the method 200 can continue at 208 with determining if the kick could possibly contain or release hydrogen sulfide. As hydrogen sulfide can be poisonous, corrosive, and flammable, the determination at 208 is performed to ensure a proper well kill operation is chosen without placing personnel or equipment in danger. If hydrogen sulfide is possibly present within the well or kick, the method 200 can continue at 210 with determining if the formation has good injectivity. At 210, the formation injectivity can be assessed, via injectivity testing, and compared to a benchmark value for the formation type. The injectivity of a formation can enable a bullheading operation to be performed, as the formation can be susceptible to fluid injection as a well control method. Accordingly, the if the formation is determined to have good injectivity at 210, the method 200 can continue at 206 with recommendation of a bullheading kill operation.

If the kick has no possibility of hydrogen sulfide release at 208, or the formation is determined to have poor injectivity at 210, the method 200 can continue at 212 with determining if the kick type is a gas migration. Kicks can be commonly formed of gas, oil, or salt water that are received into a well. Accordingly, the kick type can be assessed at 212, and the presence of a gas migration kick can further inform the decision of an optimal well control method. If the kick type is determined to be a gas migration at 212, the method 200 can continue at 214 with recommendation of a combined volumetric and stripping well control operation. The stripping operation can be utilized to locate the drillstring at the bottom of the well while the volumetric method enables the gas kick to surface while maintaining a near-constant pressure downhole. Conversely, if the kick type is not determined to be a gas migration at 212, the method 200 can continue at 216 with recommendation of a stripping control operation. The stripping control operation can enable movement of the drill string within the wellbore while containing pressures and bleeding/pumping of excess volumes.

FIG. 3 is an example of a method 300 for recommending a kill operation utilizing a decision tree when a drill bit is present on a bottom of the well. The method 300 can be implemented by the decision tree engine 114 of the kill method determination tool 112, as shown in FIG. 1. Thus, reference can be made to the example of FIG. 1 in the example of FIG. 3. Additionally, in some embodiments the method 200 and method 300 can be performed as one method. In these embodiments, a decision can be made whether the drill bit is on the bottom of the well. In these embodiments, if the drill bit is not on the bottom of the well the decision tree engine 114 can utilize the method 200 of FIG. 2. If the drill bit is on the bottom of the well, the decision tree engine 114 can utilize the method 300. Accordingly, further reference can be made to the example of FIG. 2 in the example of FIG. 3.

The method 300 can begin at 302 with receiving well control input parameters in which the drill bit is present on the bottom of the well. The well control input parameters received at 302 can be the user-defined input 102 and/or well equipment data 104 input to the well control evaluator 106 of FIG. 1. In some embodiments, at 302 the well control input parameters can be pre-processed, as by the well volume calculator 108 and the kick tolerance calculator 110 of FIG. 1. The method 300 can continue at 304 with determining if the kick volume is within the well's tolerance for a kick. At 304, the influx volume of the kick can be compared to the calculated kick tolerance to determine how the kick would affect the present well. If the influx volume exceeds the well's kick tolerance, the kick can be forced back downhole into a formation within the well and the method 300 can continue at 306. At 306, the system can recommend the utilization of a bullheading kill operation as the well control method. As stated above, the influx volume of the kick would exceed the kick tolerance of the formation in the well, and utilizing a bullheading operation to force the kick back into the formation can result in a controlled well.

If the kick volume is within the kick tolerance of the formation in the well at 304, the method 300 can continue at 308 with determining if the kick could possibly contain or release hydrogen sulfide. As hydrogen sulfide can be poisonous, corrosive, and flammable, the determination at 308 is performed to ensure a proper well kill operation is chosen without placing personnel or equipment in danger. If hydrogen sulfide is possibly present within the well or kick, the method 300 can continue at 310 with determining if the formation has good injectivity. At 310, the formation injectivity can be assessed and compared to a benchmark value for the formation type. The injectivity of a formation can enable a bullheading operation to be performed, as the formation can be susceptible to fluid injection as a well control method. Accordingly, the if the formation is determined to have good injectivity at 310, the method 300 can continue at 306 with recommendation of a bullheading kill operation.

If the kick has no possibility of hydrogen sulfide release at 308, or the formation is determined to have poor injectivity at 310, the method 300 can continue at 312 with determining if circulation through the drill string is valid. If circulation is valid through the drills string, such that flow is possible, the method 300 can continue at 314a with determining if the kick type is a gas migration. The kick type can be assessed at 314a, and the presence of a gas migration kick can further inform the decision of an optimal well control method. If the kick type is determined to be a gas migration at 314a, the method 300 can continue at 316 with recommendation of a driller's kill method. The driller's kill method requires good circulation and can be utilized to first circulate the kick influx out of the well with the weight of drilling mud, and to then kill the well with the weight of killing fluid. If circulation is not valid through the drill string, such that flow is not possible or recommended, the method 300 can continue at 314b with determining if the kick type is a gas migration. If the kick type is determined to be a gas migration, the method 300 can continue at 318 with recommendation of a volumetric kill operation, such that the gas kick may be migrated to the surface under near-constant pressures.

For both determinations at 314a,b, if the kick type is determined to not be a gas migration, the method 300 can continue at 318 with determining if the well is a vertical well. As the shape of the well can affect certain kill or control methods, the determination at 318 can alter the recommended control operation. If the well is determined to not be vertical at 318, the method 300 can continue at 316 with recommendation of a driller's kill operation. If the well is determined to be vertical at 318, the method 300 can continue at 322 with determining if the string volume is greater than the open hole volume. Depending upon the ratio of volumes between the open hole and the drill string, certain pressure control methods can differ or be impossible for well control. As such, if the string volume is greater than open hole volume, the method 300 can continue at 324 with recommendation of the driller's method and/or the wait and weight control operation. Conversely, if the string volume is not greater than open hole volume for the well, the method 300 can continue at 326 with recommendation of a wait and weight control operation only. The wait and weight control operation can be utilized to pump kill fluid into the wellbore while circulating a kick or production fluids out of the well.

Regardless of the kill or control method recommended in the method 200 or the method 300, the decision tree engine 114 can further provide the recommendation of kill method to the kill sheet generator 118 of the kill method determination tool 112. As such, the recommended kill method can be facilitated through determination of parameters and steps for performing the kill method. Further, the recommended kill method can be provided to the computing platform 124 for display to an operator via the display 130, or output as the well kill method recommendation 120.

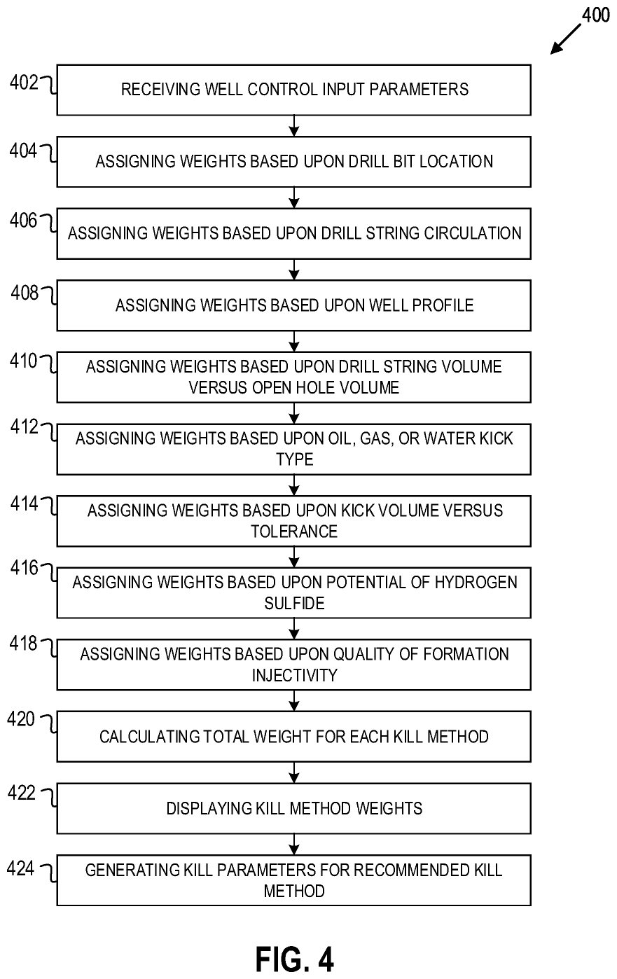

FIG. 4 is an example of a method 400 for recommending a kill operation utilizing a weighting method. The method 400 can be implemented by the weighting method engine 116 of the kill method determination tool 112, as shown in FIG. 1. Thus, reference can be made to the example of FIG. 1 in the example of FIG. 4. The method 400 can begin at 402 by with receiving well control input parameters in which the drill bit is not on the bottom of the well. The well control input parameters received at 402 can be the user-defined input 102 and/or well equipment data 104 input to the well control evaluator 106 of FIG. 1. In some embodiments, the well control input parameters received at 402 can include one or more candidate well control methods to be assessed within the method 400. In some embodiments, at 402 the well control input parameters can be pre-processed, as by the well volume calculator 108 and the kick tolerance calculator 110 of FIG. 1.

The method 400 can continue at 404 with assigning of multiple weights based upon a location of the drill bit. As stated above, the weighting method utilized in the method 400 can simultaneously compare a plurality of kill or control methods through an assignment of weights to each tested method for each variable or question. At 404, the presence of the drill bit at the bottom of the wellbore versus the presence of the drill bit above the bottom of the wellbore will determine the weights assigned to each method. As an example, the drill bit being at the bottom of the wellbore at 404 can provide a slight positive weighting to the driller's method, wait and weight method, volumetric method, and bullheading operation, and a moderate negative weighting to the stripping method and combined volumetric and stripping operation, as stripping can be unnecessary for a drill bit on the bottom of the wellbore.

The method 400 can continue at 406 with assigning of multiple weights based upon the circulation within the drill string. If drill string circulation is not valid, moderate negative weighting can be applied to the driller's method and the wait and weight method which can rely on proper circulation for well control. Further, a major positive weighting can be applied to a volumetric method which is a common choice for wells with poor circulation. Additionally, the validity of circulation through the drill string may not be of importance to the stripping method and combined stripping and volumetric methods, and the weights of these methods may not be affected at all.

The method 400 can continue at 408 with assigning of multiple weights based upon the well profile. Wellbores can be constructed in a number of designs and directions, and the profile of the well can be utilized at 408 for assigning weights to each possible operation. The wellbores are commonly divided into a vertical well, a deviated well, and a horizontal well. As such, the type of well profile can be determined at 408, and weights assigned to each method based on which profile is chosen. In some embodiments, the vertical, deviated, and horizontal well are each provided their own weights. In these embodiments, once one of the three profiles is selected, the weights of the remaining profiles are considered zero and not entered into the overall weight for determination of optimal well control.

The method 400 can continue at 410 with assigning of multiple weights based upon the comparison between the drill string volume and the open hole volume. In some embodiments, all zero weights are assigned if the open hole volume is greater than the drill string volume. As such, in these embodiments, only if the drill string volume is greater than the open hole volume will weights be assigned at 410. As discussed above, if the drill string volume is greater than the open hole volume, the wait and weight method may be less plausible for well control and at least a moderate negative weight can be applied to the wait and weight method at 410. The method 400 can continue at 412 with assigning of multiple weights based upon the type of kick within the well. As discussed above, gas, oil or salt water can commonly constitute a kick within the wellbore. Similar to the weights utilized at 408, the weights can be assigned to a single kick type at 412 based upon the kick type. For example, a gas kick can provide major positive weighting for the driller's method, the volumetric method and the combined volumetric and stripping operations. As above, in this example, no weight would be applied based upon the water or oil kick parameters.

The method 400 can continue at 414 with assigning of multiple weights based upon the comparison between the kick volume and the kick tolerance of the well. As discussed above, if the kick volume exceeds the kick tolerance, a major positive weighting can be applied to the bullheading operation with negative weights applied to the remainder. The method 400 can continue at 416 with assigning of multiple weights based upon the possibility of hydrogen sulfide in the kick. Similar to 414, if there is a possibility of hydrogen sulfide in the kick at 416, a major positive weighting can be applied to the bullheading operation with negative weights applied to the remainder. In these embodiments, the use of a bullheading operation can be preferable to prevent exposure of personnel or equipment to the dangers of the hydrogen sulfide gas.

The method 400 can continue at 418 with assigning of multiple weights based upon the quality of the formation injectivity. As above, good injectivity of the formation can increase the likelihood of a bullheading operation being successful. Accordingly, good formation injectivity at 418 can apply a moderate positive weighting to the bullheading operation while not impacting the remaining methods. However, if the formation has poor injectivity, moderate positive weighting can be applied to all methods excepting bullheading operations, while bullheading operations can have moderate negative weighting applied.

Once the desired weighting questions or variables have been addressed, the method 400 can continue at 420 with calculating a total weight for each assessed kill method. In the above description of the method 400, quantitative values can be assigned for each weighting operation. In some embodiments, the weighting can be quantified in the form of a selection index. In these embodiments, a minor weighting can be +/−about 5, a moderate weighting can be +/−about 10 to +/−about 15, and a major weighting can be +/−about 20 or +/−about 30. Accordingly, at 420 the values assigned in each weighting step can be totaled and the overall weighting, or selection index, values can be determined.

The method 400 can continue at 422 with displaying of the kill method weights determined at 420 (e.g., on the display 130 of FIG. 1). The weights, or selection indices, can be displayed in pure numerical format representing the likelihood of success for each kill method. In some embodiments, the kill method weights can be visualized at 422 such that an operator can compare each kill method in a plot of the selection index values. Regardless of the numerical value or weighting utilized, the displaying of kill methods at 422 can provide at least one recommended kill method based upon the presented parameters/pertinent questions.

The method 400 can continue at 424 with generating kill parameters for the recommended kill method. In some embodiments, the kill parameters can be generated at 424 automatically following the total weight calculations at 420. In these embodiments, the kill method with the highest weight or selection index can be passed to the kill sheet generator 118 of FIG. 1 to automatically generate a kill sheet for the recommended methods. In alternate embodiments, however, an operator can be enabled to view the kill method weights visualized at 422 and can select the desired kill operation from a list of tested kill methods. As such, the generation of a kill sheet at 424 be performed after an operator selects the desired kill method, at which point the selected kill method can be provided to the kill sheet generator 118 of FIG. 1 to generate the desired kill sheet.

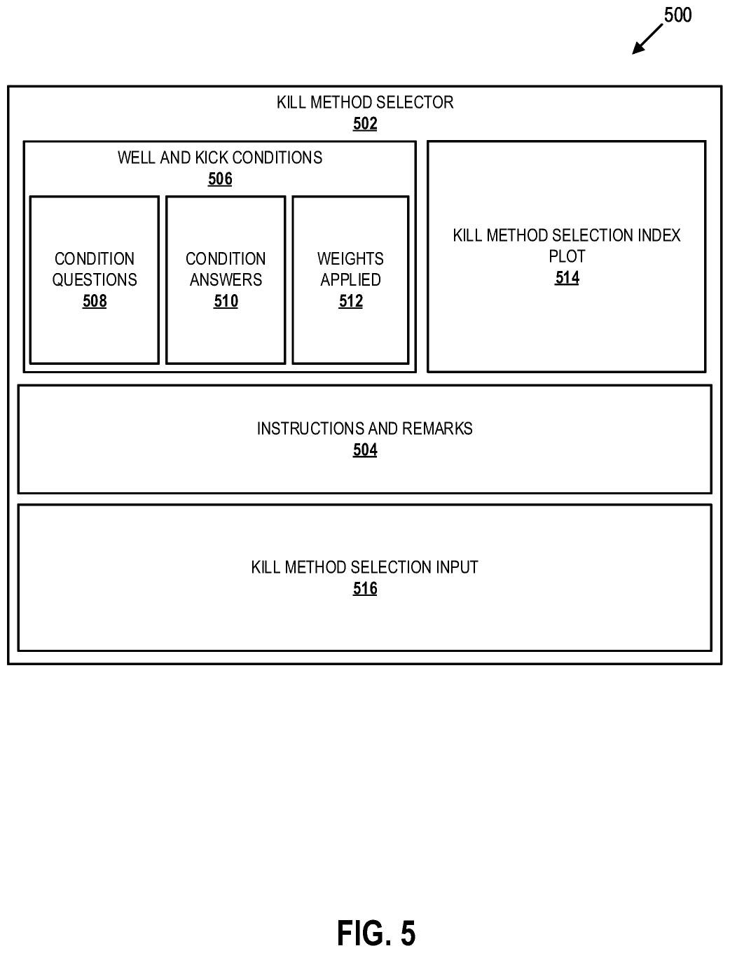

FIG. 5 is an example user interface 500 for selection of a kill method by an operator, according to an embodiment of the present disclosure. In some embodiments, the example user interface 500 can be shown on the display 130 from the computing platform 124 of FIG. 1. The example user interface 500 includes a kill method selector 502 which houses remaining information and inputs. The kill method selector 502 can include a section for instructions and remarks 504, such that an operator can properly utilize the kill method selector 502. The kill method selector 502 can include well and kick conditions 506 which are utilized in the selection of a kill method. As shown, the well and kick conditions 506 are presented for a system 100 utilizing a weighting method engine 116. However, the well and kick conditions 506 could be presented in a form to be utilized by the decision tree engine 114 without departing from the scope of this disclosure.

The well and kick conditions 506, as presented, can include condition questions 508. The condition questions 508 can correspond to the weighting factors applied at 404-418 of FIG. 4, and can be presented in an ordered list of possible factors to be considered. The well and kick conditions 506 can include condition answers 510 which have been determined from the input parameters. The condition answers 510 can be alternatively provided via input of a user or operator within the kill method selector 502, such that results can be tuned and adjusted. The well and kick conditions 506 can further include the weights applied 512 that correspond to each condition question 508 and each corresponding condition answer 510. In some embodiments, the weights applied 512 can include a total weight for each tested well kill method based upon the weights applied 512 for each conditions answer 510.

The kill method selector 502 can further include a kill method selection index plot 514. The kill method selection index plot 514 can visualize and display the total weights of each kill method, such that a user or operator can visually confirm the recommended kill method. Further, the kill method selector 502 can include a kill method selection input 516. In some embodiments, the kill method with the highest weight applied 512 can be automatically selected for kill sheet generation. In alternate embodiments, however, the user or operator can select the desired kill method within the kill method selection input 516 after consulting the kill method selection index plot 514 and/or the well and kick conditions 506. In these embodiments, a kill sheet can be generated for the kill method selected within the kill method selection input 516.

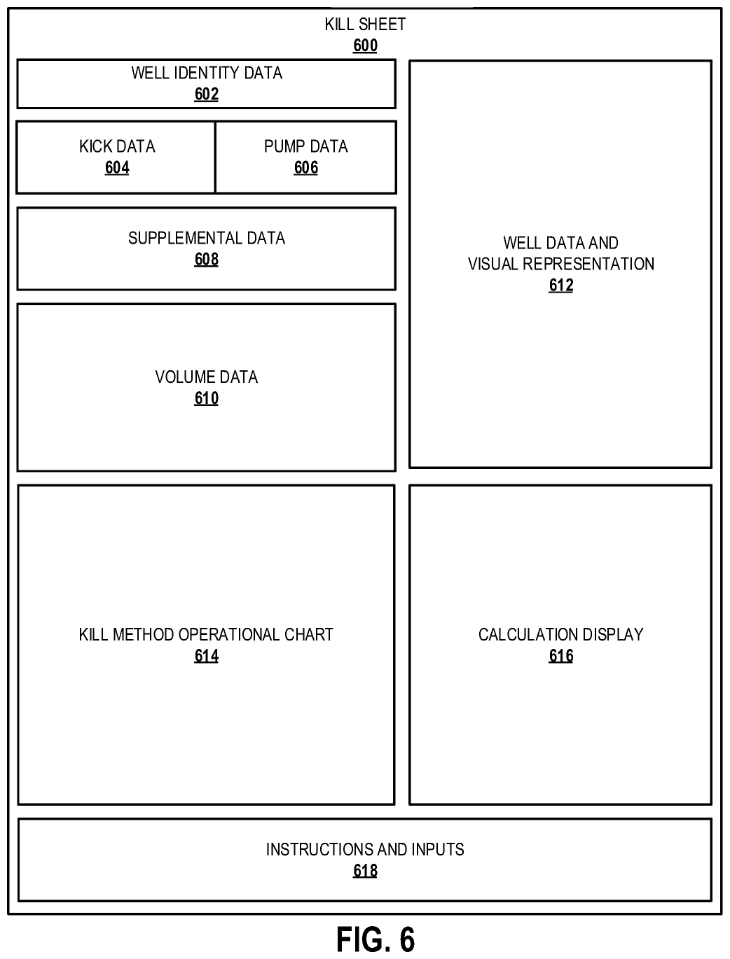

FIG. 6 is an example kill sheet 600 for performance of a selected or recommended kill method, according to an embodiment of the present disclosure. In some embodiments, the example kill sheet 600 can be shown on the display 130 from the computing platform 124 of FIG. 1. The example kill sheet 600 can include well identity data 602 which can denote bibliographic information such as the well name, the field name, and the date the kill sheet 600 was generated. The example kill sheet 600 can further include kick data 604 and pump data 606 which can be utilized in the kill parameter calculations. The kick data 604 and pump data 606 can include pressures, kick sizes, pump outputs, and additional operational information. Further, supplemental data 608 can be included in the kill sheet 600 based upon the chosen kill method. For example, a kill sheet 600 for the wait and weight method can include formation strength data in the supplemental data 608, while a kill sheet 600 for a volumetric control operation can include pressure assumptions for the working pressure and safety margin in the supplemental data 608. In some embodiments, the kill sheet 600 can require user inputs for the supplemental data 608 or other fields of the kill sheet 600 to provide the proper calculations and ordered steps. The example kill sheet 600 can further include volume data 610. The volume data 610 can include volume and dimensional information for the wellbore, the lock, the drill pipe, and any other pertinent measurement information.

Utilizing the data provided in 602-610, the example kill sheet 600 can generate or otherwise include well data and a visual representation of the well 612. The well data and visual representation of the well 612 can include some information on the casing and hole of the well and on the drilling mud, as well as a visual representation of drill bit location, profile, volume, kick type, and additional information provided. The well data and visual representation of the well 612 can aid a user or operator in verifying a layout of the well for the corresponding kill method.

Accordingly, the example kill sheet 600 can include a kill method operational chart 614 and calculation display 616 for carrying out the desired kill operation. The kill method operational chart 614 can visualize the calculations displayed in the calculation display 616, and can comprise the parameters necessary to control the well. The kill method operational chart 614 and calculation display 616 can be contextual to the selected kill method. For example, a wait and weight method can display a plot of drill pipe pressure versus number of strokes for both static and dynamic pressures in the kill method operational chart 614, and the pressures and number of strokes at each step of the operation in the calculation display 616. In a further example, a stripping operation can display a plot of the shut-in casing pressure and volume to bleed for each stand of the drill pipe in the kill method operational chart 614, the numerical values for the shut-in casing pressure and volume to bleed for each stand in the calculation display 616. The example kill sheet 600 can further include additional instructions and inputs 618. The additional instructions and inputs 618 can include contextual information or recommendations for the operator based upon the kill method selected, and can include inputs for supplemental information or to tune input information within the example kill sheet 600 itself.

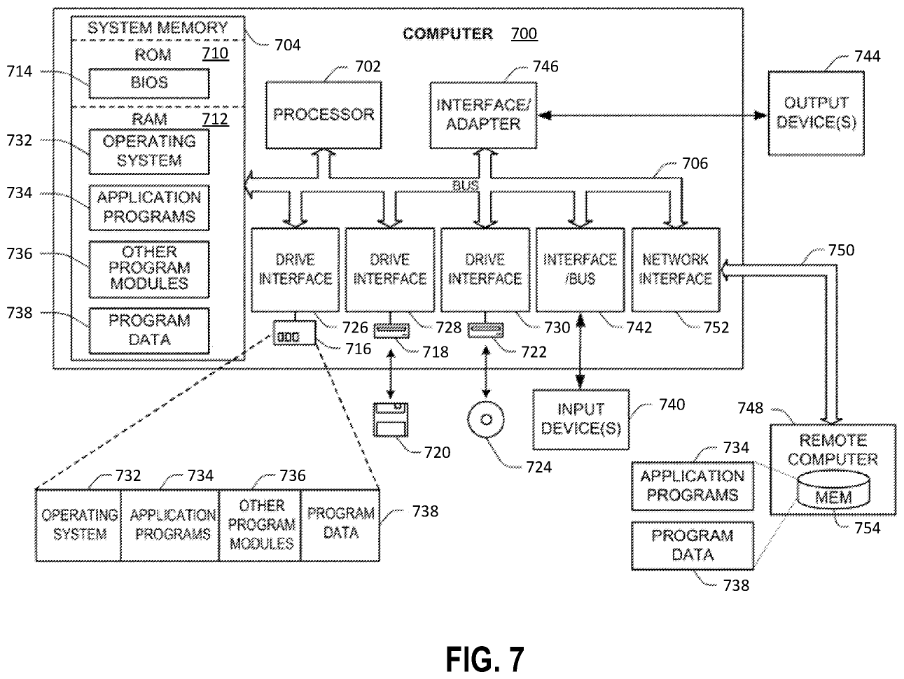

In view of the foregoing structural and functional description, those skilled in the art will appreciate that portions of the embodiments can be embodied as a method, data processing system, or computer program product. Accordingly, these portions of the present embodiments can take the form of an entirely hardware embodiment, an entirely software embodiment, or an embodiment combining software and hardware, such as shown and described with respect to the computer system of FIG. 7. Furthermore, portions of the embodiments can be a computer program product on a computer-readable storage medium having computer readable program code on the medium. Any non-transitory, tangible storage media possessing structure can be utilized including, but not limited to, static and dynamic storage devices, volatile and non-volatile memories, hard disks, optical storage devices, and magnetic storage devices, but excludes any medium that is not eligible for patent protection under 35 U.S.C. § 101 (such as a propagating electrical or electromagnetic signals per se). As an example and not by way of limitation, computer-readable storage media can include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium can be volatile, nonvolatile, or a combination of volatile and non-volatile, as appropriate.

Certain embodiments have also been described herein with reference to block illustrations of methods, systems, and computer program products. It will be understood that blocks and/or combinations of blocks in the illustrations, as well as methods or steps or acts or processes described herein, can be implemented by a computer program comprising a routine of set instructions stored in a machine-readable storage medium as described herein. These instructions can be provided to one or more processors of a general purpose computer, special purpose computer, or other programmable data processing apparatus (or a combination of devices and circuits) to produce a machine, such that the instructions of the machine, when executed by the processor, implement the functions specified in the block or blocks, or in the acts, steps, methods and processes described herein.

These processor-executable instructions can also be stored in computer-readable memory that can direct a computer or other programmable data processing apparatus to function in a particular manner, such that the instructions stored in the computer-readable memory result in an article of manufacture including instructions which implement the function specified. The computer program instructions can also be loaded onto a computer or other programmable data processing apparatus to cause a series of operational steps to be performed on the computer or other programmable apparatus to realize a computer implemented process such that the instructions which execute on the computer or other programmable apparatus provide steps for implementing the functions specified in flowchart blocks that can be described herein.

In this regard, FIG. 7 illustrates one example of a computer system 700 that can be employed to execute one or more embodiments of the present disclosure. Computer system 700 can be implemented on one or more general purpose networked computer systems, embedded computer systems, routers, switches, server devices, client devices, various intermediate devices/nodes or standalone computer systems. Additionally, computer system 700 can be implemented on various mobile clients such as, for example, a personal digital assistant (PDA), laptop computer, pager, and the like, provided it includes sufficient processing capabilities.

Computer system 700 includes processing unit 702, system memory 704, and system bus 706 that couples various system components, including the system memory 704, to processing unit 702. System memory 704 can include volatile (e.g. RAM, DRAM, SDRAM, Double Data Rate (DDR) RAM, etc.) and non-volatile (e.g. Flash, NAND, etc.) memory. Dual microprocessors and other multi-processor architectures also can be used as processing unit 702. System bus 706 can be any of several types of bus structure including a memory bus or memory controller, a peripheral bus, and a local bus using any of a variety of bus architectures. System memory 704 includes read only memory (ROM) 710 and random access memory (RAM) 712. A basic input/output system (BIOS) 714 can reside in ROM 710 containing the basic routines that help to transfer information among elements within computer system 700.

Computer system 700 can include a hard disk drive 716, magnetic disk drive 718, e.g., to read from or write to removable disk 720, and an optical disk drive 722, e.g., for reading CD-ROM disk 724 or to read from or write to other optical media. Hard disk drive 716, magnetic disk drive 718, and optical disk drive 722 are connected to system bus 706 by a hard disk drive interface 726, a magnetic disk drive interface 728, and an optical drive interface 730, respectively. The drives and associated computer-readable media provide nonvolatile storage of data, data structures, and computer-executable instructions for computer system 700. Although the description of computer-readable media above refers to a hard disk, a removable magnetic disk and a CD, other types of media that are readable by a computer, such as magnetic cassettes, flash memory cards, digital video disks and the like, in a variety of forms, can also be used in the operating environment; further, any such media can contain computer-executable instructions for implementing one or more parts of embodiments shown and described herein.

A number of program modules can be stored in drives and ROM 710, including operating system 732, one or more application programs 734, other program modules 736, and program data 738. In some examples, the application programs 734 can include the well volume calculator 108, the kick tolerance calculator 110, and the kill method determination tool 112 (as well as the subcomponents thereof), and the program data 738 can include the well kill method recommendation 120, the well kill method parameters 122, the weights applied within the weighting method engine 116, and the calculations of the well volume calculator 108 and kick tolerance calculator 110. The application programs 734 and program data 738 can include functions and methods programmed to receive input data and generate recommendations of optimal well kill methods for provided wellbore parameters, such as shown and described herein.

A user can enter commands and information into computer system 700 through one or more input devices 740, such as a pointing device (e.g., a mouse, touch screen), keyboard, microphone, joystick, game pad, scanner, and the like. For instance, the user can employ input device 740 to edit or modify user-defined input 102, select a desired well kill method, or adjust any calculations or parameters within the example user interface 500 or example kill sheet 600. These and other input devices 740 are often connected to processing unit 702 through a corresponding port interface 742 that is coupled to the system bus, but can be connected by other interfaces, such as a parallel port, serial port, or universal serial bus (USB). One or more output devices 744 (e.g., display, a monitor, printer, projector, or other type of displaying device), such as the display 130 of FIG. 1, is also connected to system bus 706 via interface 746, such as a video adapter.

Computer system 700 can operate in a networked environment using logical connections to one or more remote computers, such as remote computer 748. Remote computer 748 can be a workstation, computer system, router, peer device, or other common network node, and typically includes many or all the elements described relative to computer system 700. The logical connections, schematically indicated at 750, can include a local area network (LAN) and/or a wide area network (WAN), or a combination of these, and can be in a cloud-type architecture, for example configured as private clouds, public clouds, hybrid clouds, and multi-clouds. When used in a LAN networking environment, computer system 700 can be connected to the local network through a network interface or adapter 752. When used in a WAN networking environment, computer system 700 can include a modem, or can be connected to a communications server on the LAN. The modem, which can be internal or external, can be connected to system bus 706 via an appropriate port interface. In a networked environment, application programs 734 or program data 738 depicted relative to computer system 700, or portions thereof, can be stored in a remote memory storage device 754.

Embodiments disclosed herein include:

A. A system for recommending a well control method, the system comprising: a well control evaluator for receiving a plurality of input parameters relating to an oil and gas well and equipment, the well control evaluator including: a well volume calculator operable to determine volume parameters for the oil and gas well and a drill string of the oil and gas equipment; a kick tolerance calculator operable to determine a maximum kick tolerance acceptable within the oil and gas well; and a kill method determination tool for determining a recommended well control method via an engine using the volume parameters, maximum kick tolerance, and input parameters, and generating a kill sheet for the recommended well control method via a kill sheet generator, wherein the kill sheet includes parameters and steps for performance of the recommended well control method.

B. A method of recommending a well control method, the method comprising: receiving well control input parameters including oil and gas well data, oil and gas equipment data, formation data, and candidate well control methods; selecting one or more candidate well control methods from the well control input parameters; assigning a variable weight to each candidate well control method for each of one or more tested variables of the well control input parameters; calculating a total weight for each candidate well control method from the variable weights for each of the one or more tested variables; and determining a recommended well control method based upon the total weight for each candidate well control method.

C. A machine-readable storage medium having stored thereon a computer program for recommending a well control method of an oil and gas well using one or more well control input parameters, the computer program comprising a routine of set instructions for causing the machine to perform the steps of: selecting one or more candidate well control methods for assessment; assigning a variable weight to each candidate well control method for each of one or more tested variables of the well control input parameters; calculating a total weight for each candidate well control method from the variable weights for each of the one or more tested variables; and determining a recommended well control method based upon the total weight for each candidate well control method.

Each of embodiments A through C may have one or more of the following additional elements in any combination: Element 1: wherein the engine of the kill method determination tool is a decision tree engine for determining the recommended well control method via a plurality of binary decisions. Element 2: wherein the engine of kill method determination tool is a weighting method engine for determining a selection index of a plurality of possible well control methods. Element 3: wherein the weighting method engine assigns weights to each of the plurality of possible well control methods based upon criteria selected from the group consisting of drill bit location, drill string circulation, well profile, drill string volume, open hole volume, kick type, kick volume, kick tolerance, hydrogen sulfide potential, quality of formation injectivity, and any combination thereof. Element 4: wherein the weighting method engine visualizes the selection index for each of the plurality of possible well control methods in a kill method selection index plot. Element 5: wherein the plurality of input parameters includes user-defined inputs, well equipment data transmitted directly from sensors and operational well equipment, or a combination thereof. Element 6: further comprising a display for presenting the recommended well control method and the kill sheet to an operator. Element 7: wherein the one or more tested variables are selected from the group consisting of drill bit location, drill string circulation, well profile, drill string volume, open hole volume, kick type, kick volume, kick tolerance, hydrogen sulfide potential, quality of formation injectivity, and any combination thereof. Element 8: further comprising generating a kill sheet for the recommended well control method. Element 9: wherein the kill sheet includes control parameters and timing information for performance of the recommended well control method.

Element 10: further comprising displaying the total weight for each candidate well control method to an operator. Element 11: further comprising visualizing the total weight for each candidate control method in a plot comparing each candidate well control method. Element 12: wherein the candidate well control methods are selected from the group consisting of a driller's method, a wait and weight method, a volumetric method, a stripping operation, a lubricate and bleed method, a bullheading operation, a combined volumetric and stripping operation, and any combination thereof. Element 13: further comprising: selecting a desired well control method from a list of candidate well control methods; and generating a kill sheet for the desired well control method, wherein the kill sheet includes control parameters and timing information for performance of the desired well control method. Element 14: the set of instructions further causing the machine to perform the steps of: receiving the one or more well control input parameters from a user-defined input, from well equipment data transmitted directly from sensors and operational well equipment, or a combination thereof. Element 15: the set of instructions further causing the machine to perform the steps of: visualizing the total weight for each candidate control method in a plot comparing each candidate well control method. Element 16: the set of instructions further causing the machine to perform the steps of: generating a kill sheet for the recommended well control method, wherein the kill sheet includes control parameters and timing information for performance of the recommended well control method. Element 17: the set of instructions further causing the machine to perform the steps of: implementing the recommended well control method within the oil and gas well using the kill sheet.

By way of non-limiting example, exemplary combinations applicable to A through C include: Element 2 with Element 3; Element 2 with Element 4; Element 8 with Element 9; Element 10 with Element 11; and Element 16 with Element 17.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” can indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A system for recommending a well control method, the system comprising:
a well control evaluator for receiving a plurality of input parameters relating to an oil and gas well and equipment, the well control evaluator including:
a well volume calculator operable to determine volume parameters for the oil and gas well and a drill string of the oil and gas equipment;
a kick tolerance calculator operable to determine a maximum kick tolerance acceptable within the oil and gas well; and
a kill method determination tool for determining a recommended well control method via an engine using the volume parameters, maximum kick tolerance, and input parameters, and generating a kill sheet for the recommended well control method via a kill sheet generator,
wherein the kill sheet includes parameters and steps for performance of the recommended well control method.

2. The system of claim 1, wherein the engine of the kill method determination tool is a decision tree engine for determining the recommended well control method via a plurality of binary decisions.

3. The system of claim 1, wherein the engine of kill method determination tool is a weighting method engine for determining a selection index of a plurality of possible well control methods.

4. The system of claim 3, wherein the weighting method engine assigns weights to each of the plurality of possible well control methods based upon criteria selected from the group consisting of drill bit location, drill string circulation, well profile, drill string volume, open hole volume, kick type, kick volume, kick tolerance, hydrogen sulfide potential, quality of formation injectivity, and any combination thereof.

5. The system of claim 3, wherein the weighting method engine visualizes the selection index for each of the plurality of possible well control methods in a kill method selection index plot.

6. The system of claim 1, wherein the plurality of input parameters includes user-defined inputs, well equipment data transmitted directly from sensors and operational well equipment, or a combination thereof.

7. The system of claim 1, further comprising a display for presenting the recommended well control method and the kill sheet to an operator.

8. A method of recommending a well control method, the method comprising:
receiving well control input parameters including oil and gas well data, oil and gas equipment data, formation data, and candidate well control methods;
selecting one or more candidate well control methods from the well control input parameters;
assigning a variable weight to each candidate well control method for each of one or more tested variables of the well control input parameters;
calculating a total weight for each candidate well control method from the variable weights for each of the one or more tested variables; and
determining a recommended well control method based upon the total weight for each candidate well control method.

9. The method of claim 8, wherein the one or more tested variables are selected from the group consisting of drill bit location, drill string circulation, well profile, drill string volume, open hole volume, kick type, kick volume, kick tolerance, hydrogen sulfide potential, quality of formation injectivity, and any combination thereof.

10. The method of claim 8, further comprising generating a kill sheet for the recommended well control method.

11. The method of claim 10, wherein the kill sheet includes control parameters and timing information for performance of the recommended well control method.

12. The method of claim 8, further comprising displaying the total weight for each candidate well control method to an operator.

13. The method of claim 12, further comprising visualizing the total weight for each candidate control method in a plot comparing each candidate well control method.

14. The method of claim 8, wherein the candidate well control methods are selected from the group consisting of a driller's method, a wait and weight method, a volumetric method, a stripping operation, a lubricate and bleed method, a bullheading operation, a combined volumetric and stripping operation, and any combination thereof.

15. The method of claim 8, further comprising:
selecting a desired well control method from a list of candidate well control methods; and
generating a kill sheet for the desired well control method,
wherein the kill sheet includes control parameters and timing information for performance of the desired well control method.

16. A machine-readable storage medium having stored thereon a computer program for recommending a well control method of an oil and gas well using one or more well control input parameters, the computer program comprising a routine of set instructions for causing the machine to perform the steps of:
selecting one or more candidate well control methods for assessment;
assigning a variable weight to each candidate well control method for each of one or more tested variables of the well control input parameters;
calculating a total weight for each candidate well control method from the variable weights for each of the one or more tested variables; and
determining a recommended well control method based upon the total weight for each candidate well control method.

17. The machine-readable storage medium of claim 16, the set of instructions further causing the machine to perform the steps of:
receiving the one or more well control input parameters from a user-defined input, from well equipment data transmitted directly from sensors and operational well equipment, or a combination thereof.

18. The machine-readable storage medium of claim 16, the set of instructions further causing the machine to perform the steps of:
visualizing the total weight for each candidate control method in a plot comparing each candidate well control method.

19. The machine-readable storage medium of claim 16, the set of instructions further causing the machine to perform the steps of:
generating a kill sheet for the recommended well control method,
wherein the kill sheet includes control parameters and timing information for performance of the recommended well control method.

20. The machine-readable storage medium of claim 19, the set of instructions further causing the machine to perform the steps of:
implementing the recommended well control method within the oil and gas well using the kill sheet.
